(19) United States
(12) Patent Application Publication
(10) Pub. No.: US 2003/0029334 A1
(43) Pub. Date: Feb. 13, 2003

(54) Punch and die using cobalt alloy for preparing tablets

(76) Inventors: Hiroshi Fukada, Toyonaka-shi (JP); Hikaru Fukuyama, Ikeda-shi (JP); Etsuji Nakamura, Osaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/188,409

(22) Filed: Jun. 10, 2002

(30) Foreign Application Priority Data
Jun. 11, 2001 (JP) 175400/2001

(51) Int. Cl. B30B 1/00

(52) U.S. Cl. 100/214

(57) ABSTRACT

A punch or/and a die for tableting using a cobalt alloy as a basis material has/have an excellent corrosion resistance appropriate as a tableting machine for the preparation of tablets containing corrosive substance(s).

### BACKGROUND OF THE INVENTION

1. Field of the Invention

The present invention relates to a punch and/or a die having an excellent corrosion resistance which are/is used for the manufacture of tablets containing corrosive substances such as an acidic substance.

2. Description of the Related Art

Tablets are usually prepared by a compression molding of powder for tablets using punches and dies installed in a tableting machine. Thus, the constitution is in such a manner that die bore is formed in the die attached to a rotating table, position of a lower punch aligned at lower side of the die bore is adjusted so that the space in the die bore is set at a predetermined volume, the powder to be tableted is received in the die bore and compressed with an upper punch to form a tablet followed by pushing upward by the lower punch whereby the above-mentioned tablet is taken out from the die bore.

The above-mentioned punches should not be easily deformed by the above-mentioned compression operation which is repeated frequently and, therefore, there is demanded a high mechanical strength. Until now, they have been formed of super steel alloy or alloy tool steel and, in addition, those where chromium plating or the like is applied on the punch surface have been also used as a measure against corrosion and adherence.

As for the conventional punches and dies using the above-mentioned alloy tool steel or the like, the metal material has an inherently corrosive nature and, therefore, it is unable to be washed with water but is to be cleaned by wiping with cloth. In addition, during the storage, complicated and troublesome storage treatment such as formation of oil film on the surface and keeping under low humidity is necessary. Especially when the powder to be tableted contains corrosive substances such as an acidic substance, corrosion of the metal material is further apt to proceed whereby corrosion during the manufacture of tablets may take place and there is resulted a problem that the life as punch and die is significantly shortened.

When such corrosion occurs in punches and dies, a sliding property and a releasing property of the tableting powder on the surfaces of punches and dies lower whereby the tablets are hardly taken out from the die bores. Moreover, the tableting powder sticks on the surfaces of punches and dies whereby the surfaces of the resulting tablets become rough or clear marks are unable to be formed on the tablet surfaces or foreign substances resulted by the said corrosion may contaminate in the tablets.

Further, in order to improve the corrosion resistance and the releasing property, surfaces of punch and die comprising the above-mentioned alloy tool steel are sometimes subjected to coating such as chromium plating. However, corrosion resistance of the basis material per se is not sufficient and, in addition, the coating layer is not uniform or detachment of the coating layer is inherently unavoidable whereby a sufficient effect may not be achieved.

### SUMMARY OF THE INVENTION

An object of the present invention is to provide a punch and/or a die for preparing the tablets where the above-mentioned problems are resolved, maintenances such as production control and storage treatment are easy and corrosion resistance appropriate as a tableting machine for the preparation of tablets containing corrosive substances is available.

As a result of an intensive investigation, the present inventors have found that corrosion resistance is improved when cobalt alloy is used as a basis material for punches and dies for the preparation of tablets. They have also found that an excellent surface property such as strength is achieved by, for example, a surface finish of the basis material when the cobalt alloy is used as a basis material.

Thus, the present invention relates to the followings.

(1) A punch and/or a die for the manufacture of tablets by compression using cobalt alloy as a basis material;

(2) The punch and/or the die for the manufacture of tablets by compression according to the above (1), wherein it/they is/are for shaping into tablets containing a corrosive substance;

(3) The punch and/or the die for the manufacture of tablets by compression according to the above (2), wherein the corrosive substance is an acidic substance;

(4) The punch and/or the die for the manufacture of tablets by compression according to the above (3), wherein the acidic substance is pioglitazone hydrochloride;

(5) The punch and/or the die for the manufacture of tablets by compression according to the above (3), wherein the proportion of the acidic substance in the powder to be tableted is 0.001 to 99.5% by weight;

(6) The punch and/or the die for the manufacture of tablets by compression according to the above (1), wherein the cobalt alloy contains

(i) 36 to 68% by weight of cobalt (Co), 26 to 32% by weight of chromium (Cr), not more than 17% by weight of tungsten (W) and 0.25 to 3% by weight of carbon (C) and

(ii) not more than 3% by weight of iron (Fe) and/or not more than 2% by weight of silicon (Si) and/or not more than 22% by weight of nickel (Ni);

(7) The punch and/or the die for the manufacture of tablets by compression according to the above (1), wherein the cobalt alloy contains 47.5% by weight of cobalt, 30% by weight of chromium, 12% by weight of tungsten, 2.5% by weight of carbon, 3% by weight of iron, 2% by weight of silicon and 3% by weight of nickel;

(8) A tableting machine equipped with the punch and/or the die mentioned in the above (1); and

(9) A method for the manufacture of tablets, characterized in that, the tableting machine equipped with the punch and/or the die mentioned in the above (1) is used.

### BRIEF DESCRIPTION OF THE DRAWINGS

FIG. 1 is a brief cross-sectional view of a rotary tableting machine using the punch or the die for tableting in accordance with the present invention.

Symbols used in the drawing are as follows.

1 rotary tableting machine

2 rotary table

3 die

3a die bore

4 upper punch

5 table for holding the upper punch

6 lower punch

7 table for holding the lower punch

8 guide rail for the upper punch

9 guide rail for the lower punch

10 powder to be made into tablets

### DETAILED DESCRIPTION OF THE INVENTION

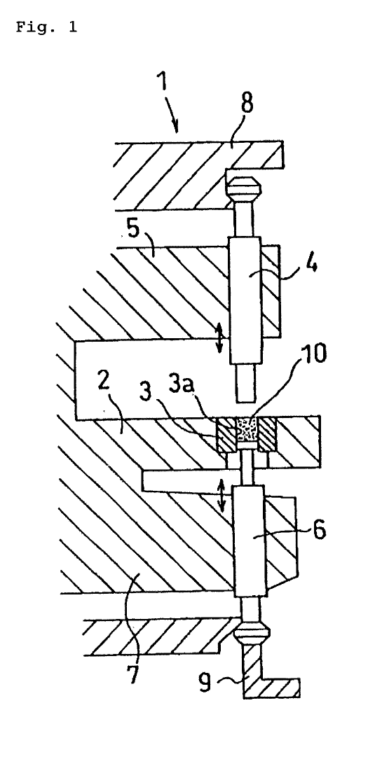

As hereunder, the preferred embodiments of the present invention will be illustrated by referring to FIG. 1.

As shown in FIG. 1, in the rotary table 2 of this rotary tableting machine 1, there are aligned plural dies in a circumferential direction with predetermined intervals and die bore 3a is formed in each die 3.

Above the die bore 3a, an upper punch 4 is held at a table 5 for holding the upper punch in an upward-and-downward movable form to the die bore 3a. Under the die bore 3a, a lower punch 6 is held at a table 7 for holding the lower punch in an upward-and-downward movable form and the top of the lower punch 6 is inserted into the die bore 3a from the downside.

Above the upper punch 4, a guide rail 8 for the upper punch is aligned so as to contact the head part formed on the top of the upper punch 4 while, under the lower punch 6, a guide rail 9 for the upper punch is aligned so as to contact the head part formed on the bottom of the lower punch 6. The above-mentioned rotary table 2, the table 5 for holding the upper punch and the table 7 for holding the lower punch are driven to rotate in a coaxial manner and, as a result of such a rotation, each of the upper punch 4 and the lower punch 6 is driven upward and downward in the predetermined position being guided by each of the guide rails 8 and 9.

In the tableting machine according to the present invention, tablets are compressed in accordance with the following procedures. Firstly, the lower punch 6 is positioned at a predetermined height by the guide rail 9 for the lower punch so that the space in the die bore 3a is set at a predetermined volume and the powder 10 to be tableted is filled in the said die bore 3a. Then, the upper punch 4 moves downward being guided by the guide rail 8 for the upper punch whereupon the said powder 10 is compressed and made into a tablet.

After that, the upper punch 4 is lifted being guided by the guide rail 8 for the upper punch and, further, the lower punch 6 is lifted by the guide rail 9 for the lower punch whereupon the above-mentioned compressed tablet is taken out from the die bore 3a.

With regard to the basis material used for the punch and/or die for the preparation of tablets according to the present invention, it is preferred to use a cobalt alloy which is characterized in that at least one of not more than about 3% by weight of iron (Fe), not more than about 2% by weight of silicon (Si) and not more than about 22% by weight of nickel (Ni) is added to a component containing about 36 to 68% by weight of cobalt (Co), about 26 to 32% by weight of chromium (Cr), not more than about 17% by weight of tungsten (W) and about 0.25 to 3% by weight of carbon (C). The most preferred one is a cobalt alloy in which about 47.5% by weight of cobalt, about 30% by weight of chromium, about 12% by weight of tungsten, about 2.5% by weight of carbon, about 3% by weight of iron and about 2% by weight of silicon are compounded. If desired, molybdenum (Mo), tantalum (Ta), niobium (Nb), etc. may be added thereto. The amount of molybdenum, tantalum or niobium used is usually about 1 to 10% by weight or, preferably, about 3 to 6% by weight to the total basis material.

With regard to the cobalt alloy, there is no inconvenience even when the commercially available cobalt alloy is used. With regard to such a commercially available product, Mitsubishi Stellite (trade name; manufactured by Mitsubishi Materials Corporation) may be specifically exemplified and, as to its grade, there may be listed No. 1, No. 3, No. 4, No. 6, No. 6H, No. 6B, No. 12, No. 12H, No. 21, No. 21E, No. 32, No. 190 and No.1016 (all manufactured by Mitsubishi Material Corporation). A preferred example is Mitsubishi Stellite (trade name) No. 1 (manufactured by Mitsubishi Material Corporation).

With regard to the basis material used in the present invention, that which is subjected to a surface finishing may be used. As to a method for such a surface finishing, there may be listed a method which has been known per se and, to be more specific, there may be exemplified surface finishing methods such as chloride treatment, fluoride treatment, cementation treatment, Cr-Dope-N treatment and nitriding treatment.

To be specific, as to a chloride treatment, about 1 to 1.5 g/m³ of chloride gas is introduced and the material is heated and kept in an atmosphere of the chloride gas whereupon the surface finishing of the basis material according to the present invention is carried out. The treating temperature in the chloride treatment is about 200 to 400° C. or, preferably, about 250 to 350° C. and heating is kept for about 5 to 20 minutes. With regard to the chloride gas, there may be used gaseous HCl; that where liquid CH₂Cl₂, CH₃Cl or the like is made gaseous; that where solid NH₄Cl, F₄Cl₂ or the like is made gaseous; etc. In addition to those, it is also possible to use other chloride where Cl is contained in a molecule are made gaseous. It is further possible to use a mixture of two or more thereof. It is furthermore possible to use chlorine gas produced by a thermal decomposition of such chloride gases using a pyrolytic apparatus or to use chlorine gas which is previously prepared.

A fluoride treatment is carried out by keeping the basis material according to the present invention at a heated state in an atmosphere of fluorine gas. The treating temperature in the fluoride treatment is about 250 to 600° C. or, preferably, about 250 to 500° C. and the heating is kept for about 10 to 80 minutes. Examples of the fluoride gas used for the fluoride treatment are NF₃, BF₃, CF₄, HF, SF₆, C₂F₆, WF₆, CHF₃, SiF₄ and ClF₃ and each of them may be used solely or two or more thereof may be used jointly. It is also possible to use that where other fluoride containing fluorine in a molecule is made gaseous. It is further possible to use fluorine gas produced by a thermal decomposition of such fluoride gases using a pyrolytic apparatus or to use fluorine gas which is previously prepared.

With regard to a cementation treatment, a surface finishing is carried out by contacting to a gas for cementation containing CO which is set at about 400 to 700° C. or, preferably, about 400 to 500° C. for about 10 to 30 hours or, preferably, about 15 to 25 hours. A surface finishing by a Cr-Dope-N treatment may be carried out by a known method per se such as, for example, a sputtering method which is a kind of a physical vapor deposition technique or, to be more specific, that can be easily carried out by a method described, for example, in Kata Gijutsu, volume 8, number 5 (issue of April, 1993) page 70 to 78.

The tablets of the present invention include not only pharmaceuticals but also agricultural chemicals, fertilizers, foods, plastics, ceramics, metals and others. Many of those tablets contain a physiologically active substance such as a pharmacologically active substance in the case of pharmaceuticals and anything may be used as the pharmacologically active substance. Particularly in the present invention, a corrosive acidic substance is listed as a substance contained in the powder to be tableted. Examples of the acidic substance are pioglitazone hydrochloride, manidipine hydrochloride, delapril hydrochloride, fursultiamine hydrochloride, cefotiam hexetil hydrochloride, thiamine hydrochloride, hydroxyzine hydrochloride and pyridoxine hydrochloride. Further, the acidic substance in the present invention is not particularly limited to those but anything may be used so far as it is a solid substance having acidity. Furthermore, the acidic substance (e.g. acidic medicament) in the present invention may, for example, be a mixture of an acidic substance and a neutral substance (e.g. neutral medicament) and the acidic substance in the present invention may be anything so far as it is a solid substance having acidity.

Proportion of the corrosive acidic substance in the powder to be tableted is not so limited but may vary within a broad range. To be more specific, it is about 0.001 to 99.5% by weight, more preferably about 0.01 to 70% by weight or, still more preferably, about 0.1 to 50% by weight.

The tablet may be anything so far as it has the so-called tablet shape and may be a tablet containing fine particles, pellets, etc. which contain the medicament. In the manufacture of such tablets, the above-mentioned pharmacologically active substance (medicament) is usually mixed with excipient, lubricant, binder, disintegrator, etc. and the resulting powder for tableting is compressed by a punch and a die to give tablets. In the present invention, an acidic substance having, for example, corrosive property is contained in the powder to be tableted. The tablets prepared as such may be further subjected to a surface coating by a conventional method to give a product. If necessary, additives for the preparation such as antiseptic, antioxidant, acidifier, sweetener, perfume, colorant and flavor may be further compounded with the powder for producing the tablets.

Appropriate examples of the excipient are saccharides such as lactose, sucrose and fructose, sugar alcohols such as D-mannitol and D-sorbitol, starch (for example, corn starch, potato starch and wheat starch), pregelatinized-starch, dextrin, microcrystalline cellulose, low-substituted hydroxypropyl cellulose, carboxymethylcellulose sodium, acacia, dextrin, pullulan, light anhydrous silicic acid, synthetic aluminum silicate, carboxymethylcellulose calcium and magnesium aluminometasilicate.

Appropriate examples of the lubricant are magnesium stearate, calcium stearate, talc, colloidal silica, polyethylene glycol and sucrose fatty acid esters.

Appropriate examples of the binder are starch, pregelatinized-starch, sucrose, gelatin, acacia, methylcellulose, carboxymethylcellulose, carboxymethylcellulose sodium, microcrystalline cellulose, sucrose, D-mannitol, trehalose, dextrin, pullulan, hydroxypropylcellulose, hydroxypropyl methylcellulose and polyvinylpyrrolidone.

Appropriate examples of the disintegrator are carboxymethylcellulose calcium, croscarmellose sodium (e.g., AcDiSol [trade name; manufactured by Asahi Kasei Corporation]), cross-linked insoluble polyvinylpyrrolidone (e.g., Kollidon CL [trade name; manufactured by BASF]), carboxymethyl starch sodium (manufactured by Matsutani Kagaku K. K.), crospovidone (ISP Inc., BASF), light anhydrous silicic acid, carmellose calcium (manufactured by Gotoku Yakuhin K. K.), low-substituted hydroxypropylcellulose and corn starch.

Examples of the acidifier are citric acid (citric acid anhydride), tartaric acid and malic acid. Examples of the artificial sweetener are saccharine sodium, dipotassium glycyrrhizinate, aspartame, stevia and thaumatin. The perfume may be either synthetic or natural and its examples are lemon, lemon lime, orange, menthol, strawberry and peppermint oil. With regard to the colorant, there may be exemplified food dyes including Food Yellow No. 5, Food Red No. 2 and Food Blue No. 2, food lake dyes, red iron oxide, talc, tar dyes, caramel, titanium dioxide, riboflavins, green tea extract and copper chlorophyllin sodium.

The above-mentioned components are selected upon desirableness and mixed by a conventional method to prepare the powder for tableting. The said powder is supplied to a tableting machine equipped with punches or/and dies of the present invention and subjected to a tableting to manufacture the tablets. The compression force (compression pressure) in the manufacture is usually about 1 to 30 kN/punch, preferably about 5 to 30 kN/punch or, more preferably, about 8 to 25 kN/punch. Inner diameter of the die is usually about 3 to 20 mm, preferably about 3 to 13 mm or, more preferably, about 4 to 10 mm. Shape of the dies may be circular or may be somewhat unusual such as oval or oblong.

Surface of the tablets prepared by compression may be coated. Examples of a coating agent therefor are hydroxypropyl methylcellulose, ethylcellulose, hydroxymethylcellulose, hydroxypropylcellulose, polyoxyethylene glycol, Tween 80, Pluronic F68, castor oil, cellulose acetate phthalate, hydroxymethylcellulose acetate succinate, Eudragit (acrylate copolymer manufactured by Rohm, West Germany), carboxymethyl ethylcellulose, polyvinylacetal diethylaminoacetate, waxes and dyes such as talc, titanium dioxide and red iron oxide.

### EXAMPLES

Example 1

According to a method known per se, there was prepared a die for tableting (hereinafter, referred to as the die of the Example) using a cobalt alloy (Mitsubishi Stellite (trade name) No. 1; manufactured by Mitsubishi Materials Corporation).

In order to confirm the corrosion resistance of the die of the Example, the said die of the Examples immediately after prepared was stored in a room (temperature: 20 to 25° C., humidity: 40 to 65%) for seven days and the corrosion resulted on the surface of the die, if any, was checked by naked eye. The result as compared with the die comprising the conventional alloy tool steel (hereinafter, referred to as SKS2) is shown in Table 1 together with the result of Example 2.

Example 2

In order to confirm the corrosion resistance of the die for tableting prepared by the same manner as in Example 1, acidic medicament which is the tableting powder consisting of 33.06 parts by weight of pioglitazone hydrochloride, 76.34 parts by weight of lactose, 3.0 parts by weight of hydroxypropylcellulose, 7.2 parts by weight of carboxymethylcellulose calcium and 0.4 parts by weight of magnesium stearate was adhered to the die of the Example and stored in a room (temperature: 20 to 25° C., humidity: 40 to 65%) for seven days and the corrosion resulted on the die surface, if any, was checked by naked eye. The result as compared with the die comprising the conventional alloy tool steel (hereinafter, referred to as SKS2) is shown in Table 1.

The SKS2 die generated corrosion even during the storage and, upon contacting to the tableting powder containing the acidic medicament, the corrosion progressed significantly while, in the die of the Example, no corrosion took place at all in any of the cases.

TABLE 1

| | | Result of Corrosion Resistance Test | |
|---|---|---|---|
| Test Conditions | | Die of the Example | SKS2 Die |
| Stored in | after 1 day | no corrosion | partially corroded |
| a Room | after 7 days | no corrosion | partially corroded |
| Contacted to | after 1 day | no corrosion | wholly corroded |
| Acidic | after 7 days | no corrosion | wholly corroded |
| Medicament | | | |

Example 3

According to a method known per se, there was prepared a punch for tableting (hereinafter, referred to as the punch of the Example) using a cobalt alloy (Mitsubishi Stellite (trade name) No. 1; manufactured by Mitsubishi Materials Corporation).

In order to confirm the corrosion resistance of the punch of the Example, it was washed with water and stored in a room (temperature: 20 to 25° C.; humidity: 40 to 65%) for seven days and the corrosion resulted on the punch surface, if any, was checked by naked eye. The result as compared with the punch comprising the conventional alloy tool steel (hereinafter, referred to as SKS2) is shown in Table 2.

The SKS2 punch generated an overall corrosion after one day from washing with water while, in the punch of the present Example 3, no corrosion was observed at all in any of the cases.

TABLE 2

| | | Result of Corrosion Resistance Test | |
|---|---|---|---|
| | | Punch of the | |
| Test Conditions | | Example | SKS2 Punch |
| Stored in a | after 1 day | no corrosion | wholly corroded |
| Room (after washed | after 7 days | no corrosion | wholly corroded |
| with water) | | | |

### INDUSTRIAL APPLICABILITY

The punch or/and the die for tableting using a cobalt alloy in the basis material according to the present invention has/have an excellent corrosion resistance and is/are able to be washed with water and, therefore, maintenances such as production control and storage treatment can be simplified and working ability can be greatly improved. Further, when the tableting powder containing corrosive substances such as an acidic medicament is made into tablets, no corrosion takes place and, therefore, there is provided a tableting property which is suitable for stable industrial production.

What is claimed is:

1. A punch and/or a die for the manufacture of tablets by compression using cobalt alloy as a basis material.

2. The punch and/or the die for the manufacture of tablets by compression according to claim 1, wherein it/they is/are for shaping into tablets containing a corrosive substance.

3. The punch and/or the die for the manufacture of tablets by compression according to claim 2, wherein the corrosive substance is an acidic substance.

4. The punch and/or the die for the manufacture of tablets by compression according to claim 3, wherein the acidic substance is pioglitazone hydrochloride.

5. The punch and/or the die for the manufacture of tablets by compression according to claim 3, wherein the proportion of the acidic substance in the powder to be tableted is 0.001 to 99.5% by weight.

6. The punch and/or the die for the manufacture of tablets by compression according to claim 1, wherein the cobalt alloy contains
(i) 36 to 68% by weight of cobalt (Co), 26 to 32% by weight of chromium (Cr), not more than 17% by weight of tungsten (W) and 0.25 to 3% by weight of carbon (C) and
(ii) not more than 3% by weight of iron (Fe) and/or not more than 2% by weight of silicon (Si) and/or not more than 22% by weight of nickel (Ni).

7. The punch and/or the die for the manufacture of tablets by compression according to claim 1, wherein the cobalt alloy contains 47.5% by weight of cobalt, 30% by weight of chromium, 12% by weight of tungsten, 2.5% by weight of carbon, 3% by weight of iron, 2% by weight of silicon and 3% by weight of nickel.

8. A tableting machine equipped with the punch and/or the die as claimed in claim 1.

9. A method for the manufacture of tablets, characterized in that, the tableting machine equipped with the punch and/or the die as claimed in claim 1 is used.
